(19) United States
(12) Patent Application Publication
(10) Pub. No.: US 2025/0174024 A1
(43) Pub. Date: May 29, 2025

(54) MANAGEMENT APPARATUS, MANAGEMENT SYSTEM, MANAGEMENT METHOD, AND STORAGE MEDIUM

(71) Applicant: NEC Corporation, Minato-ku, Tokyo (JP)

(72) Inventors: Satoshi Yamazaki, Tokyo (JP); Jianquan Liu, Tokyo (JP); Noboru Yoshida, Tokyo (JP); Youhei Sasaki, Tokyo (JP); Ryo Kawai, Tokyo (JP); Tingting Dong, Tokyo (JP); Karen Stephen, Tokyo (JP); Naoki Shindou, Tokyo (JP); Yuta Namiki, Tokyo (JP)

(73) Assignee: NEC Corporation, Minato-ku, Tokyo (JP)

(21) Appl. No.: 18/834,277

(22) PCT Filed: Feb. 10, 2022
(86) PCT No.: PCT/JP2022/005428

§ 371 Date: Jul. 30, 2024

(51) Int. Cl. G06V 20/52; G06Q 10/0631

(52) U.S. Cl. CPC G06V 20/52; G06Q 10/063114

(57) ABSTRACT

A management apparatus (102) includes a master storage (103) for storing master information (103a), and an estimation unit (104). The master information (103a) associates, with each other, an appearance predetermined for one worker or a worker group who conducts work and a kind of the work. The estimation unit (104) estimates a kind of work conducted by each of one or a plurality of workers, based on appearance information about an appearance of the one or the plurality of workers being acquired by analyzing a video in which a work region is captured, and the master information (103a).

### TECHNICAL FIELD The present invention relates to a management apparatus, a management system, a management method, and a program.

### BACKGROUND ART

Various techniques for supporting efficiency of a work step in a manufacturing base have been proposed.

For example, Non-Patent Document 1 describes that value-added time (operating rate/operating time) and wasteful time in assembly and inspection steps in a factory are automatically measured from a position of “hand” captured by a camera, and improvement on a site on a numerical basis is supported.

For example, Non-Patent Document 2 describes platform software that forms data about skeleton information (a pose such as an orientation of a body and a movement of a hand) from a video captured by a camera or a recorded video, and recognizes a motion.

Non-Patent Document 2 describes patent numbers of Patent Document 1 to Patent Document 3.

Patent Document 1 describes a technique for analyzing a pose of a worker. Patent Document 2 describes a technique for detecting an unsafe whole body pose. Patent Document 3 describes a technique for managing hand hygiene of a medical worker.

Patent Document 4 describes a technique for reducing a burden on a creator relating to an image of a target when the creator creates a report by using the image in which the target is captured. A moving image editing apparatus described in Patent Document 4 includes a recognition unit that recognizes a target captured in a predetermined period in a moving image, a registration unit that registers the target recognized by the recognition unit in association with the period, and a display unit that displays an image in which the target is recognized in the period associated with the target determined by information when the information is received.

Patent Document 5 describes a technique for computing a feature value of each of a plurality of keypoints of a human body included in an image, searching for an image including a human body having a similar pose and a human body having a similar movement, based on the computed feature value, and performing classification by putting together the similar poses and the similar movements.

Non-Patent Document 3 describes a technique related to skeleton estimation of a person.

### RELATED DOCUMENT

### Patent Document

Patent Document 1: Japanese Patent No. 6825041
Patent Document 2: Japanese Patent No. 6884819
Patent Document 3: Japanese Patent No. 6889228
Patent Document 4: Japanese Patent Application Publication No. 2020-53729
Patent Document 5: International Patent Publication No. WO2021/084677

### Non-Patent Document

Non-Patent Document 1: NEC Platforms, Ltd. “Factory Value-added Time Measurement Solution”, [online], [searched on Feb. 1, 2022], Internet <URL: https://www.necplatforms.co.jp/solution/i-iot/time-measurement/index.html>
Non-Patent Document 2: Hitachi Industry & Control Solutions, Ltd. “Person Pose/Motion Recognition Solution by AI”, [online], [searched on Feb. 1, 2022], Internet <https://info.hitachi-ics.co.jp/product/activity_evaluation/>
Non-Patent Document 3: Zhe Cao, Tomas Simon, Shih-En Wei, Yaser Sheikh, &quot: Realtime Multi-Person 2D Pose Estimation using Part Affinity Fields&quot: , The IEEE Conference on Computer Vision and Pattern Recognition (CVPR), 2017, P. 7291-7299

### DISCLOSURE OF THE INVENTION

### Technical Problem

However, Patent Documents 1 to 5 and Non-Patent Documents 1 to 3 do not describe a technique for supporting optimization of the entire work in a work region where one or a plurality of workers conduct work.

One example of an object of the present invention is, in view of the problem described above, to provide a management apparatus, a management system, a management method, and a program that solve difficulty with support for optimization of the entire work in a work region.

### Solution to Problem

One aspect of the present invention provides a management apparatus including:
a master storage unit for storing master information that associates, with each other, an appearance predetermined for one worker or a worker group who conducts work and a kind of the work; and
an estimation unit that estimates a kind of work conducted by each of one or a plurality of workers, based on appearance information about an appearance of the one or the plurality of workers being acquired by analyzing a video in which a work region is captured, and the master information.

One aspect of the present invention provides a management system including:
the management apparatus: and
a capturing apparatus that captures the work region, and transmits video data including a video in which the work region is captured.

One aspect of the present invention provides a management method including,
by a computer:
storing, in a master storage unit, master information that associates, with each other, an appearance predetermined for one worker or a worker group who conducts work and a kind of the work: and
estimating a kind of work conducted by each of one or a plurality of workers, based on appearance information about an appearance of the one or the plurality of workers being acquired by analyzing a video in which a work region is captured, and the master information.

One aspect of the present invention provides a program for causing a computer to execute:
storing master information that associates, with each other, an appearance predetermined for one worker or a worker group who conducts work and a kind of the work; and
estimating a kind of work conducted by each of one or a plurality of workers, based on appearance information about an appearance of the one or the plurality of workers being acquired by analyzing a video in which a work region is captured, and the master information.

### Advantageous Effects of Invention

The present invention can support optimization of the entire work in a work region.

### BRIEF DESCRIPTION OF THE DRAWINGS

FIG. 1 is a diagram illustrating an overview of a management system according to an example embodiment 1 of the present invention.

FIG. 2 is a flowchart illustrating an overview of management processing according to the example embodiment 1 of the present invention.

FIG. 3 is a diagram illustrating a configuration example of the management system according to the example embodiment 1 and also illustrating a diagram of a work region A viewed from above.

FIG. 4 is a diagram illustrating one example of master information according to the example embodiment 1.

FIG. 5 is a diagram illustrating a detailed example of a functional configuration of an estimation unit according to the example embodiment 1.

FIG. 6 is a diagram illustrating one example of history information according to the example embodiment 1.

FIG. 7 is a diagram illustrating a physical configuration example of the management apparatus according to the example embodiment 1.

FIG. 8 is a flowchart illustrating a detailed example of estimation processing according to the example embodiment 1.

FIG. 9 is a diagram illustrating one example of tagging.

FIG. 10 is a flowchart illustrating one example of output processing according to the example embodiment 1 of the present invention.

FIG. 11 is one example of a screen displaying the history information on a display unit.

FIG. 12 is a diagram illustrating a configuration example of a management system according to an example embodiment 2 of the present invention and also illustrating a diagram of a work region A viewed from above.

FIG. 13 is a diagram illustrating a configuration example of a management system according to an example embodiment 3 of the present invention and also illustrating a diagram of a work region A viewed from above.

FIG. 14 is a diagram illustrating one example of master information according to the example embodiment 3.

FIG. 15 is a diagram illustrating a detailed example of a functional configuration of an estimation unit according to the example embodiment 3.

FIG. 16 is a diagram illustrating a configuration example of a management system according to an example embodiment 4 of the present invention and also illustrating a diagram of a work region A viewed from above.

FIG. 17 is a diagram illustrating one example of a configuration of worker information according to the example embodiment 4.

FIG. 18 is a diagram illustrating one example of a configuration of unregistered information according to the example embodiment 4.

FIG. 19 is a diagram illustrating a detailed example of a functional configuration of an estimation unit according to the example embodiment 4.

FIG. 20 is a flowchart illustrating one example of management processing according to the example embodiment 4.

### DESCRIPTION OF EMBODIMENTS

Hereinafter, example embodiments of the present invention will be described with reference to the drawings. Note that, in all of the drawings, a similar component has a similar reference sign, and description thereof will be appropriately omitted.

### Example Embodiment 1

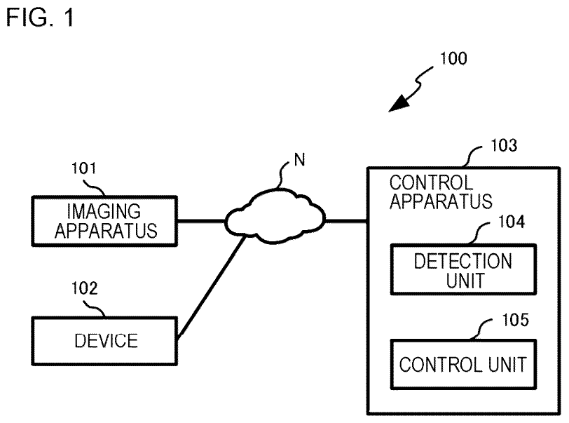

FIG. 1 is a diagram illustrating an overview of a management system 100 according to an example embodiment 1.

The management system 100 includes a capturing apparatus 101 and a management apparatus 102.

The capturing apparatus 101 captures a work region, and transmits video data including a video in which the work region is captured.

The management apparatus 102 includes a master storage unit 103 for storing master information 103a, and an estimation unit 104. The master information 103a associates, with each other, an appearance predetermined for one worker or a worker group who conducts work and a kind of the work. The estimation unit 104 estimates a kind of work conducted by each of one or a plurality of workers, based on appearance information about an appearance of the one or the plurality of workers being acquired by analyzing a video in which a work region is captured, and the master information 103a.

The management system 100 can support optimization of the entire work in which one or a plurality of workers conduct work. The management apparatus 102 can support optimization of the entire work in which one or a plurality of workers conduct work.

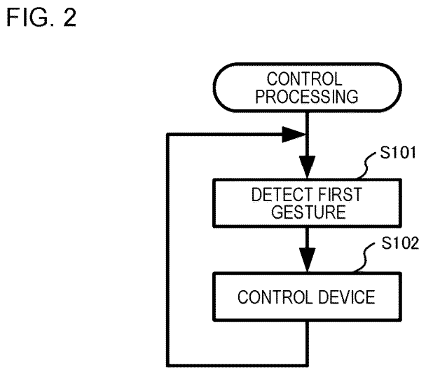

FIG. 2 is a flowchart illustrating an overview of management processing according to the example embodiment 1.

The management apparatus 102 stores, in the master storage unit 103, the master information 103a that associates, with each other, an appearance predetermined for one worker or a worker group who conducts work and a kind of the work (step S101).

The management apparatus 102 estimates a kind of work conducted by each of one or a plurality of workers, based on appearance information about an appearance of the one or the plurality of workers being acquired by analyzing a video in which a work region is captured, and the master information 103a (step S102).

The management processing can support optimization of the entire work in which one or a plurality of workers conduct work.

A detailed example of the management system 100 according to the example embodiment 1 will be described below.

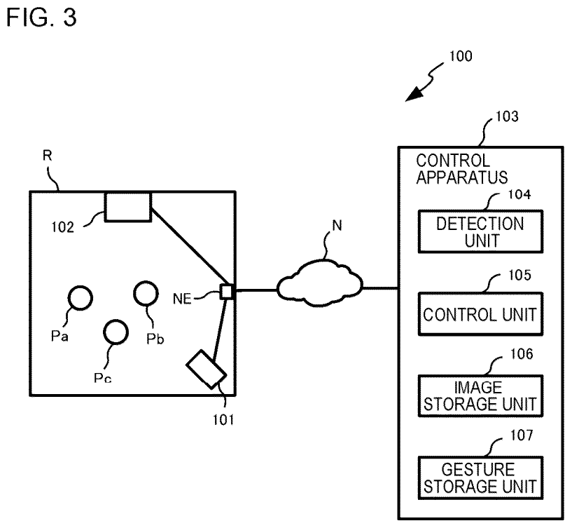

FIG. 3 is a diagram illustrating a configuration example of the management system 100 according to the example embodiment 1 of the present invention and also illustrating a diagram of a work region A viewed from above.

FIG. 3 illustrates a diagram illustrating, from above, an example in which a worker Pa conducts work A in the work region A set in a manufacturing factory of food, electronic equipment, and the like. The work A is work for attaching three predetermined parts to a semifinished product M1 moving in a direction of an arrow AR (right direction in FIG. 3) on a conveyor C.

A worker P is present in a workplace X indicated by a substantially rectangular dotted line in FIG. 3 during work of the work A. Then, the worker P repeats, by himself/herself, three steps (step A1, step A2, and step A3) of successively attaching a part one by one to the semifinished product M1 while moving from a position X1 to a position X3 in the workplace X along the conveyor C.

The worker Pa is one of the workers P who conduct work in the work region A. The worker P may be one or more. Note that, an example of group work in which a plurality of workers conduct work together will be described in detail in another example embodiment.

Further, the work A is one example of work. The work is not limited to assembly work. The work may be, for example, conveyance work, inspection work, and the like of a part, a semifinished product, a product, and the like, and is not limited to work in a manufacturing factory. The work may be formed of one or more steps determined appropriately.

Furthermore, the work region A may be a region for conducting one or more kinds of work, and a place where the work region A is set is not limited to a manufacturing factory of food, electronic equipment, and the like. The work region A may include a plurality of workplaces.

The management system 100 is a system for managing work in a work region.

As described above, the management system 100 includes the capturing apparatus 101 and the management apparatus 102. The capturing apparatus 101 and the management apparatus 102 are connected to each other via a network N. The network N is a communication network constituted in a wired manner, a wireless manner, or a combination of the manners. Thus, the capturing apparatus 101 and the management apparatus 102 can transmit and receive information, data, and the like to and from each other via the network N.

The capturing apparatus 101 is an apparatus for capturing the work region A. The capturing apparatus 101 is, for example, a camera.

The capturing apparatus 101 captures the work region A. The capturing apparatus 101 captures the work region A, and generates video data including a video in which the work region A is captured. The capturing apparatus 101 transmits the video data to the management apparatus 102 via the network N. A video desirably includes a whole body image of the worker P in the work region A.

Specifically, for example, the capturing apparatus 101 continuously captures the work region A. A frame rate at which the capturing apparatus 101 performs capturing may be appropriately set. The capturing apparatus 101 continuously generates image data including a frame image generated in each capturing. As a result, the capturing apparatus 101 generates video data including a video (moving image) formed of a plurality of frame images.

### (Functional Configuration of Management Apparatus 102)

The management apparatus 102 is an apparatus for managing work in the work region A. Specifically, the management apparatus 102 includes the master storage unit 103, the estimation unit 104, a history storage unit 105, a management unit 106, a display unit 107, an output control unit 108, and an input accepting unit 109.

The master storage unit 103 is a storage unit for storing the master information 103a.

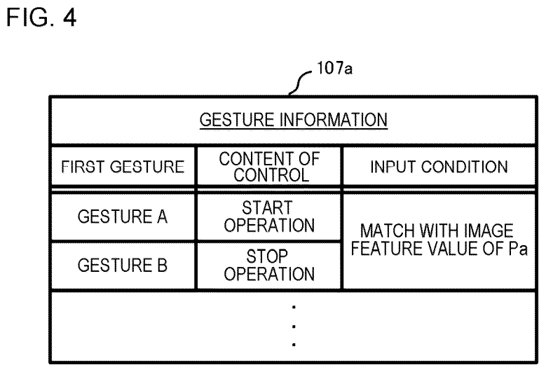

The master information 103a is information indicating a reference for determining a kind of work conducted by the worker P. FIG. 4 is a diagram illustrating one example of the master information 103a according to the present example embodiment.

Specifically, the master information 103a associates a kind of work, an appearance (master appearance information), a workplace, a step identifier (ID), and a work position/work pose with one another.

A kind of work is information for identifying a kind of work.

The master appearance information is information indicating an appearance predetermined for the worker P who conducts work. The master appearance information includes at least one piece of information indicating at least one of a whole body, clothing, a pose, and behavior of the worker P and information indicating an article used for the work. Behavior is at least one of a change or a transition in a pose, a movement (a change or a transition in a position), and the like. Information included in the master appearance information is, for example, an image and an image feature value.

Hereinafter, an “article used for work” is also simply referred to as an “article”.

A workplace is information indicating a place where work is conducted. In other words, a workplace is information indicating a range in which the worker P who conducts work is present during work. A workplace may be indicated by a range in an image, or may be indicated by a range in a real space.

A step ID is information for identifying each step included in work.

A work position/work pose is information including a work position or a work pose.

A work position is information indicating a place where each step included in work is performed. In other words, a work position is information indicating a range in which the worker P who performs each step included in work is present during work of the step. A work position may be indicated by a range in an image, or may be indicated by a range in a real space.

A work pose is information indicating a pose in each step included in work. Information included in a work pose is, for example, an image or an image feature value.

For example, for work in which a position moves during work, a work position/work pose may include a work position. For work in which a position moves during work, a work position/work pose may include a work pose.

The master information 103a illustrated in FIG. 4 includes information indicating that a predetermined appearance is “appearance A” and a workplace is “workplace X” for work of “work A”, for example. Further, the master information 103a illustrated in FIG. 4 includes information indicating that the work of “work A” includes three steps having steps IDs of “step A1” to “step A3” in which respective work positions are “position X1” to “position X3”.

When the work A is, for example, work in which a hat is worn, the appearance A includes information indicating clothing with the hat being worn.

When work B is, for example, work in which an orange workwear is worn and a baggage is conveyed by using a cart, an appearance B includes an image or an image feature value indicating clothing with the orange workwear being worn. Further, the appearance B includes an image or an image feature value indicating the cart being an article.

When work C is, for example, work in which a standing pose and a sitting pose are repeated in the same position, an appearance C includes information indicating at least one of a pose, a change in a pose, and a transition in a pose.

Further, since the work A and the work B are work accompanied by a movement of a position, “work position/work pose” includes a work position. Since the work C is work accompanied by a change in a pose, “work position/work pose” includes a work pose.

FIG. 3 is referred again.

The estimation unit 104 estimates a kind of work conducted by each of the one or the plurality of workers P, based on appearance information about an appearance of the one or the plurality of workers being acquired by analyzing a video in which the work region A is captured, and the master information 103a.

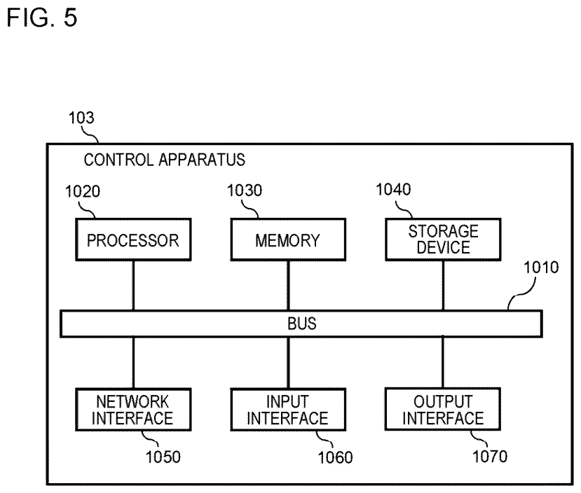

FIG. 5 is a diagram illustrating a detailed example of a functional configuration of the estimation unit 104 according to the present example embodiment.

The estimation unit 104 includes an analysis unit 111, a work estimation unit 112, and a history generation unit 113.

The analysis unit 111 acquires video data generated in the capturing apparatus 101 from the capturing apparatus 101 via the network N. The analysis unit 111 analyzes a video included in the acquired video data, i.e., a video in which the work region A is captured.

Specifically, the analysis unit 111 includes one or a plurality of analysis functions of performing processing (analysis processing) of analyzing a video. The analysis function included in the analysis unit 111 is one or a plurality of (1) an object detection function, (2) a face analysis function, (3) a person type analysis function, (4) a pose analysis function, (5) a behavior analysis function, (6) an appearance attribute analysis function, (7) a gradient feature analysis function, (8) a color feature analysis function, (9) a flow line analysis function, and the like.

(1) The object detection function detects an object from an image. The object detection function can also obtain a position of an object in an image.

As a model applied to object detection processing, there is, for example, You Only Look Once (YOLO). The object detection function detects, for example, the worker P, an article, and the like. Further, for example, the object detection function obtains a position of the worker P, an article, and the like.

Herein, “object” includes a person and an object, and the same applies to the description below.

(2) The face analysis function detects a face of a person from an image, and performs extraction of a feature value (face feature value) of the detected face, classification (division into classes) of the detected face, and the like. The face analysis function can also obtain a position of a face in an image. The face analysis function can also determine identity of persons detected from different images, based on a degree of similarity between face feature values of the persons detected from the different images, and the like.

(3) The person type analysis function performs extraction of a human body feature value (for example, a value indicating an overall feature such as fatness/slimness of a body shape, height, and clothing) of a person included in an image, classification (division into classes) of the person included in the image, and the like. The person type analysis function can also determine a position of a person in an image. The person type analysis function can also determine identity of persons included in different images, based on human body feature values of the persons included in the different images, and the like.

(4) The pose analysis function detects a joint point of a person from an image, and creates a stick figure model connecting the joint point. Then, the pose analysis function estimates a pose of the person by using information about the stick figure model, and performs extraction of a feature value (pose feature value) of the estimated pose, classification (division into classes) of the person included in the image, and the like. The pose analysis function can also determine identity of persons included in different images, based on pose feature values of the persons included in the different images, and the like.

For example, the pose analysis function estimates a pose such as a standing pose, a sitting pose, and a crouching pose from an image, and extracts a pose feature value indicating each pose. Further, for example, the pose analysis function can estimate, from an image, a pose for an article detected by using the object detection function and the like, and extract a pose feature value indicating the pose.

For example, the techniques disclosed in Patent Document 5 and Non-Patent Document 3 can be applied to the pose analysis function.

(5) Behavior analysis processing can estimate a movement of a person by using the information about the stick figure model, a change in a pose, and the like, and perform extraction of a feature value (movement feature value) of the movement of the person, classification (division into classes) of a person included in an image, and the like. In the behavior analysis processing, height of a person can be estimated and a position of a person in an image can be determined by using the information about the stick figure model. In the behavior analysis processing, for example, behavior such as a change or a transition in a pose and a movement (a change or a transition in a position) can be estimated, and a movement feature value of the behavior can be extracted.

(6) The appearance attribute analysis function can recognize an appearance attribute accompanying a person. The appearance attribute analysis function performs extraction of a feature value (appearance attribute feature value) related to a recognized appearance attribute, classification (division into classes) of a person included in an image, and the like. The appearance attribute is an attribute in terms of an appearance, and includes, for example, one or more of a color of clothing, a color of shoes, a hairstyle, wearing or non-wearing of a hat, a tie, glasses, and the like, and the like.

(7) The gradient feature analysis function extracts a feature value (gradient feature value) of a gradient in an image. For example, a technique such as SIFT, SURF, RIFF, ORB, BRISK, CARD, and HOG can be applied to gradient feature detection processing.

(8) The color feature analysis function detects an object from an image, and performs extraction of a feature value (color feature value) of a color of the detected object, classification (division into classes) of the detected object, and the like.

The color feature value is, for example, a color histogram and the like. The color feature analysis function can detect, for example, a person included in an image and an article used for work. Further, for example, the color feature analysis function can classify an article into classes such as the conveyor C, a worktable, a part, a semifinished product, a product, a baggage to be conveyed, and a tool/utensil/equipment (for example, a cart/platform truck for conveying a baggage and a screwdriver for screwing).

(9) The flow line analysis function can obtain a flow line (track of a movement) of a person included in a video by using a result of determination of identity in any of the analysis functions of (2) to (6) described above, for example. Specifically, for example, by connecting persons determined to be the same between images different on a time-series basis, a flow line of the person can be obtained. Note that, when a video captured by a plurality of the capturing apparatuses 101 that capture different captured regions, and the like, the flow line analysis function can also obtain a flow line across a plurality of videos in which the different captured regions are captured.

An image feature value includes, for example, a detection result of an article in the object detection function, a face feature value, a human body feature value, a pose feature value, a movement feature value, an appearance attribute feature value, a gradient feature value, a color feature value, and a flow line.

Note that, each of the analysis functions of (1) to (9) may appropriately use a result of an analysis performed by the other analysis function.

The analysis unit 111 analyzes a video in which the work region A is captured by using the analysis functions of (1) to (9) described above, and detects an object (the worker P and an article) included in the video. Further, the analysis unit 111 generates appearance information about an appearance of the detected worker P. The appearance information is time-series information about an appearance of a worker.

The appearance information includes at least one piece of information indicating at least one of a whole body, clothing, a pose, and behavior of the worker P and information indicating an article used for work. Information included in the appearance information is, for example, an image or an image feature value.

The work estimation unit 112 estimates a kind of work conducted by the worker P, based on the appearance information generated by the analysis unit 111 and the master information 103a.

Further, the work estimation unit 112 estimates a work time of the worker P, based on the appearance information generated by the analysis unit 111 and the master information 103a. A work time of the worker P is a time related to work conducted by the worker P.

A work time includes a time related to working hours, a time related to an actual work period of time, and a time related to a step execution period of time.

Working hours are a period of time in which the worker P is working, and is, for example, a period of time in which the worker P having a predetermined appearance is present in the work region A. An actual work period of time is a period of time in which the worker P is actually conducting work, and is, for example, a period of time in which the worker P having a predetermined appearance is present in a workplace according to work. A step execution period of time is a period of time in which the worker P performs each step, and is a period of time in which a work position or a work pose according to each step is maintained. A time related to each of working hours, an actual work period of time, and a step execution period of time includes a start time and an end time.

Note that, a work time is not limited to this, and may be, for example, a time related to one or two of working hours, an actual work period of time, and a step execution period of time.

The history generation unit 113 generates history information 105a, based on a result estimated by the work estimation unit 112.

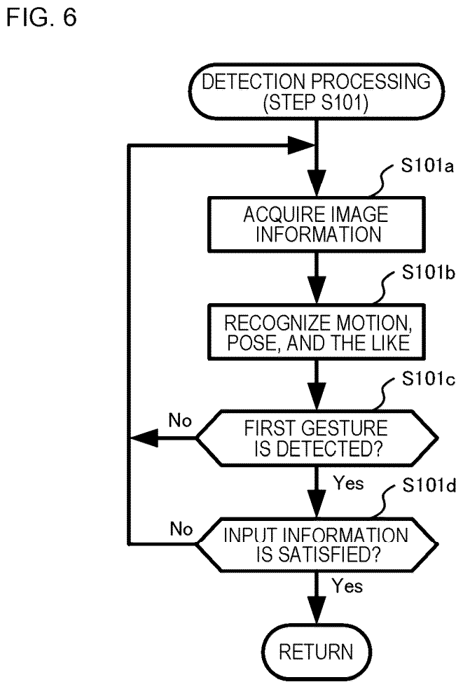

FIG. 6 is a diagram illustrating one example of the history information 105a according to the present example embodiment. The history information 105a is information indicating a history of work of the worker P. The history information 105a according to the present example embodiment includes a worker ID, a kind of work, a time related to working hours, a time related to an actual work period of time, and a time related to a step execution period of time.

A worker ID included in the history information 105a is information for identifying the worker P. The worker ID may be appropriately provided.

A kind of work included in the history information 105a is a kind of work conducted by the worker P associated with the kind of work. The kind of work is a kind of work estimated by the work estimation unit 112.

The history information 105a illustrated in FIG. 6 includes an example of a history in which the worker Pa having a worker ID of “Pa” has conducted “work A”. The history information 105a illustrated in FIG. 6 indicates that working hours of the worker Pa are from “ST1” to “ST2” and an actual work period of time is from “WT1” to “WT2” during the working hours. Further, the history information 105a indicates that steps A1 to A3 have been performed during the actual work period of time. For example, the period from “WT1” to “WT2” is an example of a time related to a step execution period of time of the step A1 performed first in the actual work period of time.

Since the worker P may take a break, the history information 105a may include times related to a plurality of actual work periods of time for one period of working hours. Further, since a step included in work is normally repeated for a plurality of time in one actual work period of time, the history information 105a may include times related to a plurality of step execution periods of time for one actual work period of time.

FIG. 3 is referred again.

The history storage unit 105 is a storage unit for storing the history information 105a.

The management unit 106 generates management information for supporting management of work in the work region A, based on the history information 105a. For example, the management unit 106 generates the management information by performing statistical processing on the history information 105a.

The display unit 107 displays various types of information.

The output control unit 108 performs control for outputting information. For example, the output control unit 108 may display information on the display unit 107, and may output electronic data including information.

For example, the output control unit 108 displays the history information 105a, the management information, and the like on the display unit 107. For example, the output control unit 108 outputs electronic data including the history information 105a, the management information, and the like.

The input accepting unit 109 accepts an input of a user.

The functional configuration of the management system 100 according to the example embodiment 1 is mainly described above. Hereinafter, a physical configuration of the management system 100 according to the present example embodiment will be described.

### (Physical Configuration of Management System 100)

The management system 100 is physically formed of the capturing apparatus 101 and the management apparatus 102 connected to each other via the network N. Each of the capturing apparatus 101 and the management apparatus 102 is physically formed of a different single apparatus.

Note that, the management apparatus 102 may be physically formed of a plurality of apparatuses connected to each other via an appropriate communication line such as the network N. The capturing apparatus 101 and the management apparatus 102 may be physically formed of a single apparatus. When the management system 100 includes a plurality of the capturing apparatuses 101, for example, one or the plurality of capturing apparatuses 101 may include at least a part of the management apparatus 102.

The management apparatus 102 is physically a general-purpose computer, for example.

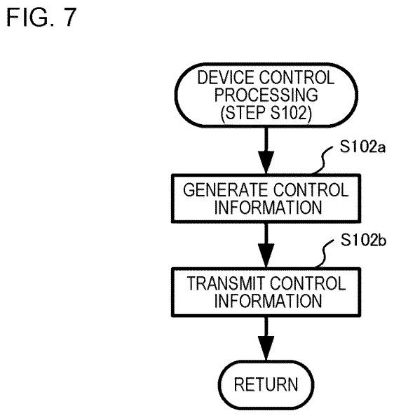

Specifically, for example, as illustrated in FIG. 7, he management apparatus 102 physically includes a bus 1010, a processor 1020, a memory 1030, a storage device 1040, a network interface 1050, an input interface 1060, and an output interface 1070.

The bus 1010 is a data transmission path for allowing the processor 1020, the memory 1030, the storage device 1040, the network interface 1050, the input interface 1060, and the output interface 1070 to transmit and receive data with one another. However, a method for connecting the processor 1020 and the like to one another is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module for achieving a function of the management apparatus 102. The processor 1020 reads each program module onto the memory 1030 and executes the program module, and a function associated with the program module is achieved.

The network interface 1050 is an interface for connecting the management apparatus 102 to the network N.

The input interface 1060 is a touch panel, a keyboard, a mouse, and the like as an interface for a user to input information.

The output interface 1070 is a liquid crystal panel, an organic electro-luminescence (EL) panel, and the like as an interface for providing information to a user. The output interface 1070 constitutes the display unit 107. Note that, the output interface 1070 may be built in the management apparatus 102, and may be provided outside the management apparatus 102.

The physical configuration of the management system 100 according to the example embodiment 1 is mainly described above. Hereinafter, a motion of the management system 100 according to the present example embodiment will be described.

### (Motion of Management System 100)

### (Management Processing)

The management apparatus 102 performs the management processing (see FIG. 2). The management processing is processing for managing work in the work region A. For example, when the management apparatus 102 accepts a start instruction from a user, the management apparatus 102 starts the management processing. For example, when the management apparatus 102 accepts an end instruction from a user, the management apparatus 102 ends the management processing.

FIG. 2 is referred.

The input accepting unit 109 stores the master information 103a in the master storage unit 103 according to an input of a user (step S101).

Note that, the input accepting unit 109 may perform step S101 at a time of initial setting when the management apparatus 102 is used for the first time, a change in the master information 103a, and the like. Thus, the input accepting unit 109 may perform step S101 when, for example, there is a request from a user.

The estimation unit 104 estimates a kind of work conducted by the worker P, based on appearance information about an appearance of the worker P being acquired by analyzing a video in which the work region A is captured, and the master information 103a (step S102).

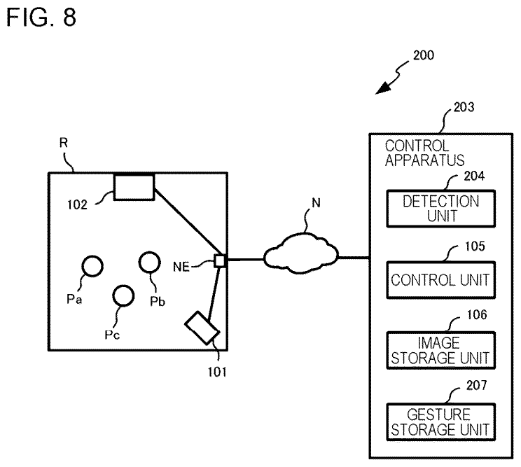

FIG. 8 is a flowchart illustrating a detailed example of estimation processing (step S102) according to the present example embodiment.

FIG. 8 is referred.

The analysis unit 111 acquires video data generated in the capturing apparatus 101 from the capturing apparatus 101 via the network N (step S102a).

The analysis unit 111 acquires, for example, video data of a predetermined period at a predetermined time from the capturing apparatus 101. The predetermined period may be appropriately determined, and is, for example, one day. The predetermined time may be appropriately determined, and is, for example, a time at which no work is conducted in the work region A. As described above, the video data are a moving image formed of a plurality of frame images. The video data include a capturing time of each of the frame images.

Note that, the analysis unit 111 may acquire the video data in real time from the capturing apparatus 101. In this case, the analysis unit 111 may hold the video data of a predetermined period. The analysis unit 111 may acquire the video data from the capturing apparatus 101 via an apparatus that holds the video data. The analysis unit 111 may acquire the video data via a storage medium instead of the network N.

The analysis unit 111 analyzes a video included in the video data acquired in step S102a, i.e., a video in which the work region A is captured, and detects an object included in the video (step S102b).

For example, when the analysis unit 111 analyzes a video in which the work region A illustrated in FIG. 3 is captured, the analysis unit 111 detects the worker Pa, the conveyor C, and the like.

FIG. 8 is referred again.

The analysis unit 111 repeatedly performs steps S102d to S102g for all of the workers P detected in step S102c (loop A: step S102c).

The analysis unit 111 provides a worker ID to the worker P being a processing target, and also performs tagging (step S102d).

Specifically, the analysis unit 111 provides the same worker ID to the same worker P included in a plurality of frame images, based on a result of identity determination of a person using, for example, a face feature value.

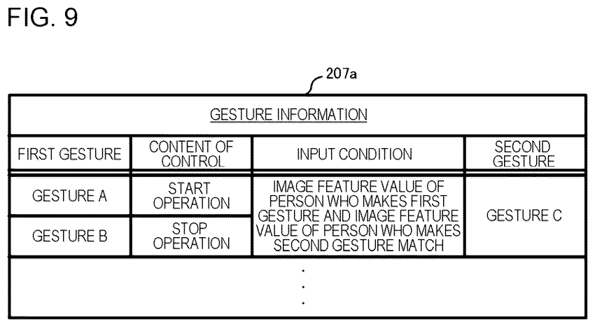

The analysis unit 111 performs tagging on an image of the worker P being the processing target included in each of the frame images. In tagging, for example, the analysis unit 111 provides a mark (for example, a rectangular frame) indicating an image region of the worker P, and also associates the worker ID with the mark. FIG. 9 is a diagram illustrating one example of tagging. FIG. 9 illustrates an example in which an image of the worker Pa is surrounded by a mark of a rectangular frame, and a worker ID “Pa” of the worker Pa is associated with the frame.

Note that, the analysis unit 111 may detect specific behavior instructed by a user, and perform tagging on an image of a worker who performs the specific behavior. The tag may include information (for example, wording, a mark, a symbol, and the like) indicating specific behavior instructed by a user.

FIG. 8 is referred again.

The analysis unit 111 analyzes a video included in the video data acquired in step S102a, i.e., a video in which the work region A is captured, and generates appearance information about the worker P being the processing target (step S102e).

For example, the analysis unit 111 analyzes a video by using the object detection function, the person type analysis function, the pose analysis function, the appearance attribute analysis function, the color feature analysis function, and the like. By using an output result of the functions, the analysis unit 111 acquires appearance information indicating a whole body of the worker P being the processing target, clothing, a pose, behavior, an article, and the like.

The work estimation unit 112 estimates a kind of work conducted by the worker P being the processing target, based on the appearance information acquired in step S102e and the master information 103a (step S102f).

Specifically, for example, the work estimation unit 112 determines master appearance information that coincides with the appearance information acquired in step S102e. Herein, “coinciding” means substantially coinciding, and also includes a case of being different in a predetermined range. The work estimation unit 112 determines a kind of work associated with the determined master appearance information in the master information 103a. The work estimation unit 112 estimates the determined kind of work as a kind of work conducted by the worker P being the processing target.

For example, in the master information 103a illustrated in FIG. 4, the master appearance information includes the appearance A to the appearance C. The work estimation unit 112 determines the master appearance information among the appearance A to the appearance C coinciding with the appearance information about the worker Pa being the processing target.

For example, the appearance A is assumed to coincide with the appearance information about the worker Pa being the processing target. In this case, the work estimation unit 112 estimates that the work A associated with the appearance A in the master information 103a is a kind of work conducted by the worker Pa.

The work estimation unit 112 estimates a work time of the work conducted by the worker P, based on the appearance information acquired in step S102c and the master information 103a (step S102g).

### (Estimation of Time Related to Working Hours)

The work estimation unit 112 determines a frame image appearing in the video for the first time with an appearance according to the kind of the work estimated in step S102f. The work estimation unit 112 estimates a capturing time of the frame image as a start time of working hours.

The work estimation unit 112 determines a frame image appearing lastly in the video with the appearance according to the kind of the work estimated in step S102f. The work estimation unit 112 estimates a capturing time of the frame image as an end time of the working hours.

### (Estimation of Time Related to Actual Work Period of Time)

The work estimation unit 112 determines a frame image group with the appearance, in the workplace X, according to the kind of the work estimated in step S102f. At this time, when there are a plurality of actual work periods of time, the work estimation unit 112 determines a plurality of frame image groups.

The work estimation unit 112 estimates a capturing time of a first frame image of each of the determined one or plurality of frame image groups as a start time of an actual work period of time. The work estimation unit 112 estimates a capturing time of a last frame image of each of the determined one or plurality of frame image groups as an end time of the actual work period of time.

### (Estimation of Time Related to Step Execution Period of Time)

The work estimation unit 112 determines a first frame image associated with a work position or a work pose from each of the one or the plurality of frame image groups determined for estimating the time related to the actual work period of time. The work estimation unit 112 estimates a capturing time of the frame image as a start time of a step associated with the work position or the work pose.

Then, the work estimation unit 112 determines a frame image in which the work position or the work pose change to a work position or a work pose associated with a next step from each of the one or the plurality of frame image groups determined for estimating the time related to the actual work period of time. The work estimation unit 112 estimates a capturing time of the frame image as an end time of the previous step, and also estimates the capturing time as a start time of the next step.

For example, with reference to FIG. 4, processing of estimating a time related to a step execution period of time of the work A will be described. The work estimation unit 112 determines a first frame image associated with “position X1” from each of one or a plurality of frame image groups determined for estimating a time related to an actual work period of time. The work estimation unit 112 estimates a capturing time of the frame image as a start time of “step A1”.

Next, the work estimation unit 112 determines a frame image in which a work position changes from “position X1” to “position X2” from each of the one or the plurality of frame image groups determined for estimating the time related to the actual work period of time. The work estimation unit 112 estimates a capturing time of the frame image as an end time of “step A1” being the previous step, and also estimates the capturing time as a start time of “step A2” being a next step. The work estimation unit 112 successively repeats such processing until a last frame image of each of the one or the plurality of frame image groups.

The work estimation unit 112 estimates a capturing time of the last frame image of each of the one or the plurality of frame image groups as an end time of a step (normally, “step A3” being a last step of the work A) associated with a work position in the frame image.

Further, for example, with reference to FIG. 4, processing of estimating a time related to a step execution period of time of the work C will be described. The work estimation unit 112 determines a first frame image associated with “pose Z1” from each of one or a plurality of frame image groups determined for estimating a time related to an actual work period of time. The work estimation unit 112 estimates a capturing time of the frame image as a start time of “step C1”.

Next, the work estimation unit 112 determines a frame image in which a work pose changes from “pose Z1” to “pose Z2” from each of the one or the plurality of frame image groups determined for estimating the time related to the actual work period of time. The work estimation unit 112 estimates a capturing time of the frame image as an end time of “step C1” being the previous step, and also estimates the capturing time as a start time of “step C2” being a next step. The work estimation unit 112 successively repeats such processing until a last frame image of each of the one or the plurality of frame image groups.

The work estimation unit 112 estimates a capturing time of the last frame image of each of the one or the plurality of frame image groups as an end time of a step (normally, “step C2” being a last step of the work C) associated with a work pose in the frame image.

FIG. 8 is referred again.

When the analysis unit 111 performs steps S102d to S102g for all of the workers P detected in step S102c, the analysis unit 111 ends the loop A (step S102c).

The analysis unit 111 generates the history information 105a, based on a result of steps S102f to S102g performed with each of the one or the plurality of workers P as the processing target (step S102h).

The analysis unit 111 generates, for example, the history information 105a for each worker P as illustrated in FIG. 6. The analysis unit 111 stores the generated history information 105a in the history storage unit 105.

The analysis unit 111 returns to the management processing (see FIG. 2), and repeatedly performs the estimation processing (step S102).

By performing the management processing, the history information 105a including a kind of work conducted in the work region A can be accurately collected and managed. Therefore, optimization of the entire work in the work region can be supported.

### (Output Processing)

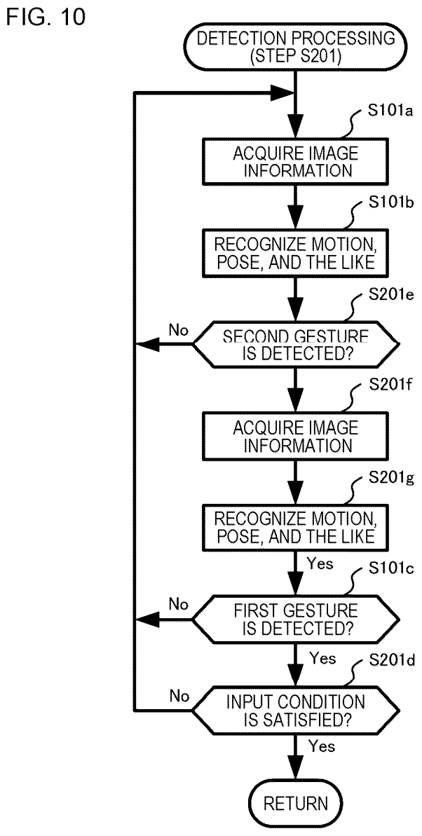

FIG. 10 is a flowchart illustrating one example of output processing according to the example embodiment 1. The output processing is processing of performing the statistical processing on the history information 105a, and performing output.

The management unit 106 generates management information, based on the history information 105a, by performing the statistical processing on the history information 105a, and the like (step S111).

Specifically, for example, the management unit 106 obtains the number of the workers P who conduct the same kind of work, and generates management information including the number of the workers P. Further, for example, the management unit 106 obtains, by time period, the number of the workers P who conduct the same kind of work, and generates management information including the number of the workers P by the time period. Various changes may be made in the statistical processing in step S111.

Furthermore, for example, the management unit 106 obtains at least one of a time required for each step being performed in each actual work period of time by each worker, a proportion of the time required, and the like, and generates management information including at least one of the time required for each step, the proportion of the time required, and the like.

The output control unit 108 outputs information such as the history information 105a and the management information in response to an instruction of a user (step S112).

Specifically, for example, the output control unit 108 displays information on the display unit 107 by outputting the information to the display unit 107. Further, for example, the output control unit 108 stores electronic data including information in a storage place specified by a user in a storage unit (not illustrated) of the management apparatus 102, and transmits the electronic data to a transmission destination specified by a user.

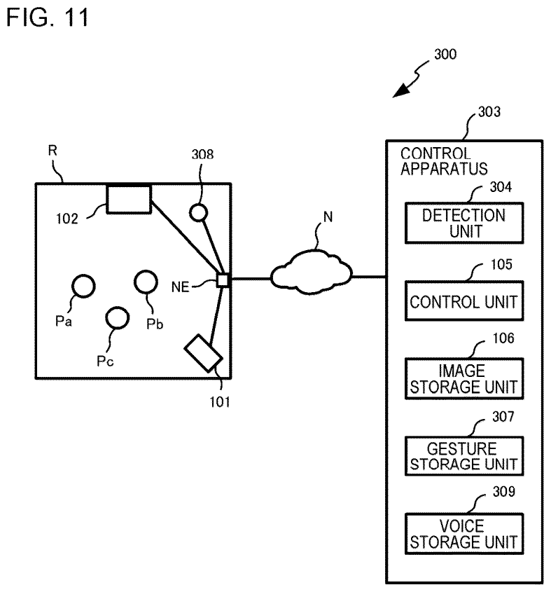

FIG. 11 is one example of a screen displaying the history information 105a on the display unit 107. FIG. 11 includes an example of displaying detailed information in an actual work period of time by putting a cursor on a line indicating the actual work period of time being displayed. FIG. 11 illustrates an example in which the detailed information is a proportion of a time required for each step in the actual work period of time.

By performing the output processing, the statistical processing can be performed on the history information 105a, and management information needed to optimize the entire work in the work region A can be acquired. Therefore, optimization of the entire work in the work region can be supported. Further, information such as the history information 105a and management information can be output in a manner easy for a user to view. Therefore, optimization of the entire work in the work region can be supported.

The example embodiment 1 of the present invention is described above.

### (Action and Effect)

According to the present example embodiment, the management apparatus 102 includes the master storage unit 103 for storing the master information 103a, and the estimation unit 104. The master information 103a associates, with each other, an appearance predetermined for the worker P who conducts work and a kind of the work. The estimation unit 104 estimates a kind of work conducted by each of one or a plurality of workers, based on appearance information about an appearance of the one or the plurality of workers being acquired by analyzing a video in which the work region A is captured, and the master information 103a.

In this way, a kind of work conducted in the work region A can be estimated. Thus, for example, the history information 105a including a kind of work conducted in the work region A can be accurately collected and managed. For example, the entire work in the work region A can be optimized by using the history information 105a. Therefore, optimization of the entire work in the work region A can be supported.

According to the present example embodiment, a predetermined appearance (master appearance information) includes at least one piece of information indicating a whole body, clothing, a pose, and behavior of the worker P who conducts work and information indicating an article used for the work.

In general, the worker P who conducts work often wears predetermined clothing being determined in a manufacturing factory and the like. The predetermined clothing is, for example, a workwear, a uniform, a hat, shoes, and the like determined according to work conducted by the worker P. In a case of a workwear and a uniform, a color may be different according to work conducted by the worker P. For a hat, whether to wear the hat is often determined according to work conducted by the worker P. Further, when a hat is worn, a color of the hat may be different according to work conducted by the worker P. For shoes, safety shoes, work shoes, shoes for a clean room, and the like may be determined according to work conducted by the worker P. In this case, a color of the shoes may be different according to work conducted by the worker P.

Further, in work, at least one of a pose and behavior often has a pattern in a certain manner such as a movement in a certain range and repetition of standing and sitting.

Furthermore, in work, there is often an article used for the work. The article is, for example, the conveyor C, a worktable, a part, a semifinished product, a product, a baggage to be conveyed, and a tool/utensil/equipment (for example, a cart/platform truck for conveying a baggage and a screwdriver for screwing).

Thus, a kind of work conducted by the worker P can be estimated based on a video, based on at least one piece of information indicating at least one of a whole body, clothing, a pose, and behavior of the worker P and information indicating an article used for the work. Therefore, optimization of the entire work in the work region A can be supported.

According to the present example embodiment, the management apparatus 102 includes the management unit 106 that outputs management information, based on a result estimated by the estimation unit 104. For example, the management information includes the number of workers who conduct the same kind of work. Further, for example, the management information includes the number of workers who conduct the same kind of work by time period.

Particularly, information about a whole body of the worker P can include information indicating clothing, a pose, and the like. In such a manner, the information about the whole body of the worker P can include a plurality of pieces of information, and thus time and effort to set master appearance information can be reduced further than when each of a plurality of pieces of information about clothing, a pose, and the like is prepared and the master appearance information is set. Therefore, optimization of the entire work in the work region A can be supported while time and effort of a user are reduced.

According to the present example embodiment, the estimation unit 104 further estimates a work time of each of the one or the plurality of workers P, based on the appearance information and the master information 103a.

In this way, the history information 105a including the work time in addition to a kind of work conducted in the work region A can be accurately collected and managed. For example, the entire work in the work region can be optimized by using the history information 105a. Therefore, optimization of the entire work in the work region A can be supported.

According to the present example embodiment, a video includes a whole body image of the worker P in the work region A.

In general, due to an orientation of a face of the worker P and the like, the face of the worker P may not be included in a video at a level of clearness to the extent that identity of a person can be determined based on a face feature value. Even in such a case, by a video including a whole body image of the worker P, identity of a person can be determined by using, for example, a human body feature value, a hairstyle, a build, and the like. In this way, the history information 105a including a kind of work conducted in the work region A can be accurately and reliably collected and managed. Therefore, optimization of the entire work in the work region A can be further supported.

### Example Embodiment 2

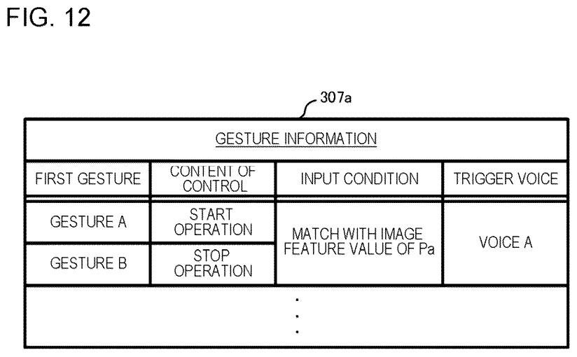

FIG. 12 is a diagram illustrating a configuration example of a management system 200 according to an example embodiment 2 of the present invention and also illustrating a diagram of a work region A viewed from above. In the present example embodiment, description overlapping the example embodiment 1 will be appropriately omitted for simplifying the description, and a difference from the example embodiment 1 will be mainly described.

The management system 200 includes a plurality of capturing apparatuses 101 and a management apparatus 102.

The plurality of capturing apparatuses 101 are an apparatus for capturing an the entire work region A. The plurality of capturing apparatuses 101 capture the work region A from different directions. Each of the plurality of capturing apparatuses 101 is similar to the capturing apparatus 101 according to the example embodiment 1.

In the example embodiment 2, an estimation unit 104 estimates a kind of work conducted by each of one or a plurality of workers P, based on appearance information about an appearance of the one or the plurality of workers being acquired by analyzing a plurality of videos in which the work region A is captured, and master information 103a.

Except for the points, the management system 200 may be functionally and physically configured similarly to the management system 100 according to the example embodiment 1. Further, the management system 200 may operate similarly to the management system 100 according to the example embodiment 1.

The example embodiment 2 of the present invention is described above.

### (Action and Effect)

According to the present example embodiment, the estimation unit 104 estimates a kind of work conducted by each of one or a plurality of workers, based on appearance information about an appearance of the one or the plurality of workers being acquired by analyzing a plurality of videos in which the work region A is captured, and the master information 103a. The plurality of videos are videos in which the work region A is captured from different directions.

In such a manner, by using videos captured from a plurality of different directions, a video in which the entire work region A is mostly captured without an omission can be acquired. Thus, for example, an arrangement of the worker P can be changed by recognizing presence of a vacant space in a workplace and the like. Therefore, optimization of the entire work in the work region A can be supported.

Further, by performing capturing from different directions, a face of the worker P is easily captured. Thus, identity of a person can be reliably and easily determined based on a face feature value. In this way, history information 105a including a kind of work conducted in the work region A can be accurately and reliably collected and managed. Therefore, optimization of the entire work in the work region A can be further supported.

### Example Embodiment 3

In an example embodiment 3, an example of group work in which a plurality of workers P conduct work together will be described. In the present example embodiment, description overlapping the example embodiment 1 will be appropriately omitted for simplifying the description, and a difference from the example embodiment 1 will be mainly described.

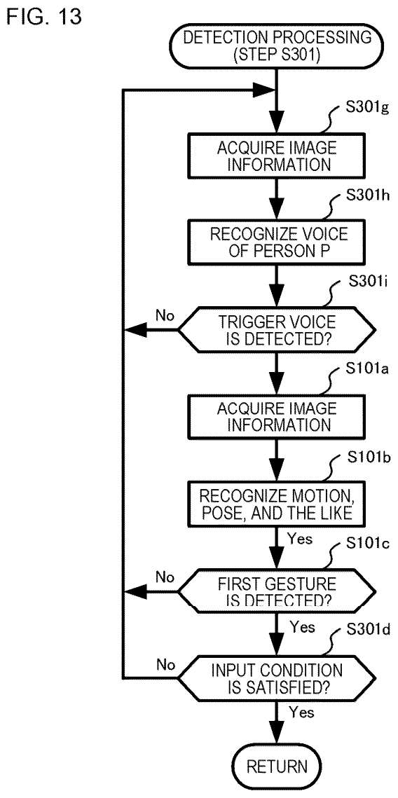

FIG. 13 is a diagram illustrating a configuration example of a management system 300 according to the example embodiment 3 of the present invention and also illustrating a diagram of a work region A viewed from above.

The management system 300 includes a capturing apparatus 101 similar to that in the example embodiment 1, and a management apparatus 302 instead of the management apparatus 102 according to the example embodiment 1.

The management apparatus 302 includes a history storage unit 105, a management unit 106, a display unit 107, an output control unit 108, and an input accepting unit 109 similar to those in the example embodiment 1. The management apparatus 302 includes a master storage unit 303 and an estimation unit 304 instead of the master storage unit 103 and the estimation unit 104 according to the example embodiment 1.

Similarly to the example embodiment 1, the master storage unit 303 is a storage unit for storing master information 303a.

Similarly to the example embodiment 1, the master information 303a is information indicating a reference for determining a kind of work conducted by the worker P. In the present example embodiment, the master information 303a is different from the master information 103a according to the example embodiment 1 in a point that the master information 303a for group work is included.

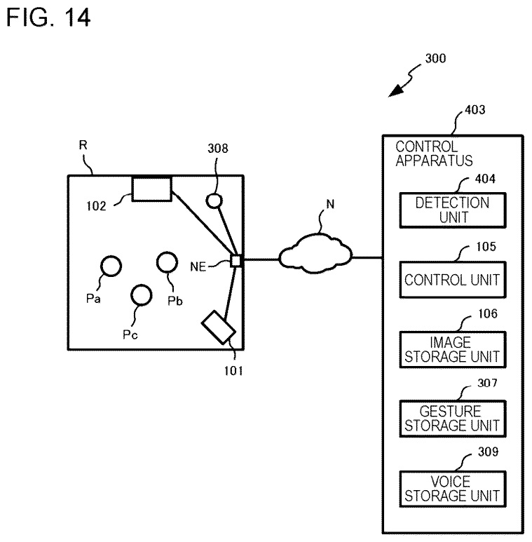

FIG. 14 is a diagram illustrating one example of the master information 303a according to the present example embodiment.

Similarly to the master information 103a according to the example embodiment 1, the master information 303a according to the present example embodiment associates, with each other, an appearance predetermined for the worker P who conducts work and a kind of the work. In addition, the master information 303a associates, with each other, an appearance predetermined for a worker group who conducts work and a kind of the work.

The worker group is a group formed of a plurality of workers who conduct work together.

Master appearance information for group work, i.e., an appearance predetermined for group work includes at least one of the number of the plurality of workers P constituting a worker group and a positional relationship in addition to an appearance similar to that in the example embodiment 1.

The master information 303a illustrated in FIG. 14 includes information in which the master appearance information, and a workplace, a step ID, and a work position/work pose similar to those in the example embodiment 1 are associated with “work D” being group work.

The master appearance information associated with “work D” includes at least one piece of information indicating at least one of a whole body, clothing, a pose, and behavior of each of a plurality of workers constituting a worker group and information indicating an article used for the work. Further, the master appearance information includes the number of the plurality of workers constituting the worker group and a positional relationship. FIG. 14 illustrates an example in which the number of the workers is “two” and a positional relationship is “facing at distance within ○○ pixel”. “○○ pixel” is an example of representing a distance by a pixel number of a screen (distance in the screen). The distance may be represented by a distance in a real space.

Similarly to the example embodiment 1, the estimation unit 304 estimates a kind of work conducted by each of the one or the plurality of workers P, based on appearance information about an appearance of the one or the plurality of workers being acquired by analyzing a video in which the work region A is captured, and the master information 103a.

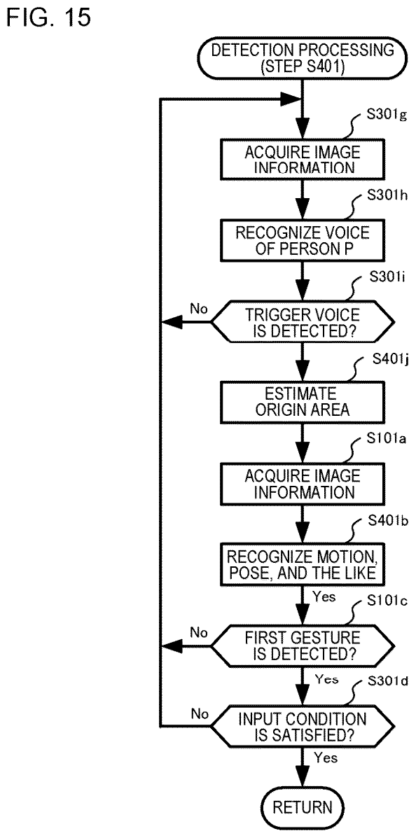

FIG. 15 is a diagram illustrating a detailed example of a functional configuration of the estimation unit 304 according to the present example embodiment.

The estimation unit 304 includes a history generation unit 113 similar to that in the example embodiment 1, and an analysis unit 311 and a work estimation unit 312 instead of the analysis unit 111 and the work estimation unit 112 according to the example embodiment 1.

Similarly to the example embodiment 1, the analysis unit 311 analyzes a video in which the work region A is captured by using an analysis function, and detects an object (the worker P and an article) included in the video. Further, similarly to the example embodiment 1, the analysis unit 311 generates appearance information about an appearance of the detected worker P.

When the plurality of workers P are included in the same frame image, the appearance information according to the present example embodiment includes at least one of a positional relationship and the number of the plurality of workers P. For example, the appearance information includes a distance (for example, a distance in a screen, a distance in a real space) between the plurality of workers P, an orientation of each of the plurality of workers P, and the like.

The work estimation unit 312 estimates a kind of work conducted by the worker P, based on the appearance information generated by the analysis unit 111 and the master information 303a.

Specifically, similarly to the example embodiment 1, the work estimation unit 312 estimates a kind of work, based on at least one piece of information indicating at least one of a whole body, clothing, a pose, and behavior of the worker P and information indicating an article used for the work, which are included in the appearance information and the master appearance information.

When the appearance information includes at least one of a positional relationship and the number of the workers P, the work estimation unit 312 according to the present example embodiment further estimates a kind of work for group work, based on at least one of the number and the positional relationship included in the appearance information and the master appearance information.

Except for the points, the management system 300 may be functionally and physically configured similarly to the management system 100 according to the example embodiment 1.

In estimation processing according to the present example embodiment, in step S102e, the analysis unit 311 analyzes a video in which the work region A is captured, and generates appearance information including a whole body, clothing, a pose, behavior, an article, and the like similar to the example embodiment 1. In addition, when there is a frame image including the worker P being a processing target and the other worker P, the analysis unit 311 generates appearance information including at least one of a positional relationship and the number of the plurality of workers P.

In step S102f, the work estimation unit 112 estimates a kind of work conducted by the worker P being the processing target, based on the appearance information acquired in step S102e and the master information 103a, similarly to the example embodiment.

Specifically, when the appearance information includes at least one of a positional relationship and the number of the workers P, the work estimation unit 312 according to the present example embodiment estimates a kind of work for group work, based on the appearance information and the master appearance information.

More specifically, for example, when the appearance information includes the number of the workers P, the work estimation unit 312 determines master appearance information in which the number of people, a whole body, clothing, a pose, behavior, an article, and the like coincide with the appearance information. Further, for example, when the appearance information includes a positional relationship between the workers P, the work estimation unit 312 determines master appearance information in which a positional relationship, a whole body, clothing, a pose, behavior, an article, and the like coincide with the appearance information.

Furthermore, for example, when the appearance information includes the number and a positional relationship of the workers P, the work estimation unit 312 determines master appearance information in which the number of people, a positional relationship, a whole body, clothing, a pose, behavior, an article, and the like coincide with the appearance information.

Even when the appearance information includes at least one of a positional relationship and the number of the workers P, a part or the whole of the plurality of workers P may conduct work being conducted by one person. Thus, for example, after the work estimation unit 312 performs the processing for estimating a kind of work for group work, the work estimation unit 312 determines master appearance information in which information (such as a whole body, clothing, a pose, behavior, and an article) other than the number and a positional relationship coincides with the appearance information, similarly to the example embodiment 1.

Then, in both of the cases, the work estimation unit 312 determines a kind of work associated with the determined appearance information in the master information 103a. The work estimation unit 112 estimates the determined kind of the work as the kind of the work conducted by the worker P being the processing target.

Except for the points, management processing according to the present example embodiment may be similar to the management processing according to the example embodiment 1.

The example embodiment 3 of the present invention is described above.

### (Action and Effect)

According to the present example embodiment, the master information 103a associates, with each other, an appearance predetermined for a worker group who conducts work and a kind of the work. The worker group is formed of a plurality of workers who conduct work together.

In this way, a kind of work for group work conducted in the work region A can be estimated. Thus, for example, history information 105a including a kind of work for group work can be accurately collected and managed. For example, the entire work in the work region A can be optimized by using the history information 105a. Therefore, optimization of the entire work in the work region A can be supported.

According to the present example embodiment, an appearance (master appearance information) predetermined for a worker group who conducts work includes at least one of the number and a positional relationship of a plurality of workers constituting the worker group.

In this way, a kind of work for group work conducted in the work region A can be estimated. Thus, for example, the history information 105a including a kind of work for group work can be accurately collected and managed. For example, the entire work in the work region A can be optimized by using the history information 105a. Therefore, optimization of the entire work in the work region A can be supported.

### Example Embodiment 4

Normally, a predetermined worker P often goes in and out of a work region A. However, a person other than the predetermined worker P may go in and out of the work region A. In an example embodiment 4, an example of processing when a person other than the predetermined worker P is included in a video of the work region A will be described. In the present example embodiment, description overlapping the example embodiment 1 will be appropriately omitted for simplifying the description, and a difference from the example embodiment 1 will be mainly described.

FIG. 16 is a diagram illustrating a configuration example of a management system 400 according to the example embodiment 4 of the present invention and also illustrating a diagram of the work region A viewed from above.

The management system 400 includes a capturing apparatus 101 similar to that in the example embodiment 1, and a management apparatus 402 instead of the management apparatus 102 according to the example embodiment 1.

The management apparatus 402 functionally includes an output control unit 408 instead of the output control unit 108 according to the example embodiment 1. In addition, the management apparatus 402 includes a registration storage unit 410. Except for the units, the management apparatus 402 may be configured similarly to the management apparatus 102 according to the example embodiment 1.

The registration storage unit 410 is a storage unit for storing worker information 410a and unregistered information 410b.

The worker information 410a is information about the worker P. The worker information 410a is registered in advance in the registration storage unit 410.

FIG. 17 is a diagram illustrating one example of a configuration of the worker information 410a according to the present example embodiment. The worker information 410a associates a worker ID and an image feature value with each other.

An image feature value is an image feature value of the worker P indicated by a worker ID associated with the image feature value. The image feature value is, for example, a face feature value, which is not limited thereto.

The unregistered information 410b is information about an unregistered person. An unregistered person is a person not being registered in the worker information 410a among people who go in and out of the work region A.

FIG. 18 is a diagram illustrating one example of a configuration of the unregistered information 410b according to the present example embodiment. The unregistered information 410b associates an unregistered ID, an image, and information about behavior with one another.

An unregistered ID is information for identifying an unregistered person.

An image is an image including an unregistered person indicated by an unregistered ID associated with the image.

Information about behavior is information about behavior of an unregistered person indicated by an unregistered ID associated with the information.

Note that, the unregistered information 410b may include at least one of an image and information about behavior.

When a person included in a video in which the work region A is captured is an unregistered person, an estimation unit 404 generates the unregistered information 410b about the unregistered person in addition to the function of the estimation unit 104 according to the example embodiment 1. The estimation unit 404 stores the unregistered information 410b in the registration storage unit 410.

FIG. 19 is a diagram illustrating a detailed example of a functional configuration of the estimation unit 404 according to the present example embodiment.

The estimation unit 404 includes a work estimation unit 112 and a history generation unit 113 similar to those in the example embodiment 1, and an analysis unit 411 instead of the analysis unit 111 according to the example embodiment 1.

The analysis unit 411 includes a function similar to that of the analysis unit 411 according to the example embodiment 1. Furthermore, the analysis unit 411 determines whether a person included in a video in which the work region A is captured is the worker P. When the analysis unit 411 determines that the person is not the worker P, the analysis unit 411 generates the unregistered information 410b and stores the unregistered information 410b in the registration storage unit 410.

FIG. 16 is referred again.

The output control unit 408 displays the unregistered information 410b in addition to history information 105a and management information on a display unit 107. Further, the output control unit 408 outputs electronic data including the unregistered information 410b. Specifically, for example, the output control unit 408 forms a list of pieces of information about an unregistered person included in the unregistered information 410b, displays the list of the unregistered persons on the display unit 107, and outputs electronic data including the list of the unregistered persons.

The management system 400 may be physically configured similarly to the management system 100 according to the example embodiment 1.

Similarly to the example embodiment 1, the management apparatus 402 according to the present example embodiment performs management processing. The management processing according to the present example embodiment includes estimation processing partially different from the estimation processing (step S102) according to the example embodiment 1.

FIG. 20 is a flowchart illustrating one example of the management processing according to the present example embodiment. FIG. 20 illustrates one example of a different portion of the management processing according to the present example embodiment from the estimation processing (step S102) according to the example embodiment 1.

The analysis unit 411 performs steps S102a to S102b similar to those in the example embodiment 1.

The analysis unit 411 determines whether a person included in a video in which the work region A is captured is the worker P, based on the worker information 410a (step S402a).

Specifically, for example, the analysis unit 411 determines whether a face feature value coinciding with a face feature value of the person detected in step S102b is included in the worker information 410a.

When a face feature value coinciding with the face feature value of the detected person is not included in the worker information 410a, the analysis unit 411 determines that the person is not the worker P. When a face feature value coinciding with the face feature value of the detected person is included in the worker information 410a, the analysis unit 411 determines that the person is the worker P.

When the analysis unit 411 determines that the person is not the worker P (step S402a: No), the analysis unit 411 generates the unregistered information 410b (step S402b). The analysis unit 411 stores the generated unregistered information 410b in the registration storage unit 410.

Specifically, the analysis unit 411 provides an unregistered ID to the person (unregistered person) determined not to be the worker P. At this time, the analysis unit 411 may provide an unregistered ID according to, for example, a predetermined rule. The analysis unit 411 generates the unregistered information 410b by associating an image including the person (unregistered person) determined not to be the worker P and information about behavior with the unregistered ID.

The image of the person determined not to be the worker P is an image of the person included in a video in which the work region A is captured. The image is one or both of a still image and a moving image. The image includes at least one of a face image, a whole body image, and the like. The information about behavior is, for example, a movement feature value, a pose feature value, and a transition or a change in the pose feature value, which is not limited thereto.

When the analysis unit 411 determines that the person is the worker P (step S402a: No), the analysis unit 411 performs processing after step S102c similar to that in the example embodiment 1. However, in step S102d, the analysis unit 111 may use a worker ID included in the worker information 410a as a worker ID provided to a worker being a processing target.

The example embodiment 4 of the present invention is described above.

### (Action and Effect)

According to the present example embodiment, when a person included in a video in which the work region A is captured is an unregistered person who is not registered in the worker information 410a, the unregistered information 410b about the unregistered person is generated.

In this way, a person other than the worker P who goes in and out of the work region A can be managed. Therefore, safety management, information management, and the like in the work region A can be improved.

According to the present example embodiment, the unregistered information 410b includes at least one of an image including an unregistered person and information about behavior of the unregistered person.

In this way, a person other than the worker P who goes in and out of the work region A can be managed based on at least one of an image and behavior of the person. Therefore, safety management, information management, and the like in the work region A can be improved.

According to the present example embodiment, the output control unit 408 displays the unregistered information 410b on the display unit 107.

In this way, a user can view the unregistered information 410b, and manage a person other than the worker P who goes in and out of the work region A. Therefore, safety management, information management, and the like in the work region A can be improved.

While the example embodiments and the modification examples of the present invention have been described with reference to the drawings, the example embodiments and the modification examples are only exemplification of the present invention, and various configurations other than the above-described example embodiments and modification examples can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, the example embodiments and the modification examples described above can be combined within an extent that a content is not inconsistent.

A part or the whole of the above-described example embodiments may also be described in supplementary notes below, which is not limited thereto.

1.

A management apparatus including:
a master storage unit for storing master information that associates, with each other, an appearance predetermined for one worker or a worker group who conducts work and a kind of the work: and
an estimation unit that estimates a kind of work conducted by each of one or a plurality of workers, based on appearance information about an appearance of the one or the plurality of workers being acquired by analyzing a video in which a work region is captured, and the master information.
   2.

The management apparatus according to supplementary note 1, wherein
the predetermined appearance includes at least one piece of information indicating a whole body, clothing, a pose, and behavior of the one worker who conducts the work or a plurality of workers constituting the worker group, and information indicating an article used for the work.
   3.

The management apparatus according to supplementary note 1 or 2, wherein
the worker group is formed of a plurality of workers who conduct the work together.
   4.

The management apparatus according to any one of supplementary notes 1 to 3, wherein
the appearance predetermined for the worker group who conducts the work includes at least one of a number and a positional relationship of a plurality of workers constituting the worker group.
   5.

The management apparatus according to any one of supplementary notes 1 to 4, further including
a management unit that outputs management information, based on a result estimated by the estimation unit.
   6.

The management apparatus according to supplementary note 5, wherein
the management information includes a number of workers who conduct a same kind of work.
   7.

The management apparatus according to supplementary note 6, wherein
the management information includes a number of workers who conduct a same kind of work by time period.
   8.

The management apparatus according to any one of supplementary notes 1 to 7, wherein
the estimation unit further estimates a work time of each of the one or the plurality of workers, based on the appearance information and the master information.
   9.

The management apparatus according to any one of supplementary notes 1 to 8, wherein
the video is one of a plurality of videos in which the work region is captured from different directions, and
the estimation unit estimates a kind of work conducted by each of one or a plurality of workers, based on appearance information about an appearance of the one or the plurality of workers being acquired by analyzing the plurality of videos in which the work region is captured, and the master information.
   10.

The management apparatus according to any one of supplementary notes 1 to 9, wherein,
when a person included in the video is an unregistered person who is not registered in worker information, the estimation unit further generates unregistered information about the unregistered person.
   11.

The management apparatus according to supplementary note 10, wherein
the unregistered information includes at least one of an image including the unregistered person and behavior of the unregistered person.
   12.

The management apparatus according to supplementary note 10 or 11, further including
an output control unit that displays the unregistered information on a display unit.
   13.

A management system including:
the management apparatus according to any one of supplementary notes 1 to 12; and
a capturing apparatus that captures the work region, and transmits video data including a video in which the work region is captured.
   14.

A management method including,
by a computer:
storing, in a master storage unit, master information that associates, with each other, an appearance predetermined for one worker or a worker group who conducts work and a kind of the work; and
estimating a kind of work conducted by each of one or a plurality of workers, based on appearance information about an appearance of the one or the plurality of workers being acquired by analyzing a video in which a work region is captured, and the master information. 15.

A program for causing a computer to execute:
storing master information that associates, with each other, an appearance predetermined for one worker or a worker group who conducts work and a kind of the work; and
estimating a kind of work conducted by each of one or a plurality of workers, based on appearance information about an appearance of the one or the plurality of workers being acquired by analyzing a video in which a work region is captured, and the master information.

### Reference Signs List

100, 200, 300, 400 Management system
101 Capturing apparatus
102, 302, 402 Management apparatus
103, 303 Master storage unit
103a, 303a Master information
104, 304, 404 Estimation unit
105 History storage unit
105a History information
106 Management unit
107 Display unit
108, 408 Output control unit
109 Input accepting unit
111, 311, 411 Analysis unit
112, 312 Work estimation unit
113 History generation unit
410 Registration storage unit
410a Worker information
410b Unregistered information
A Work region
P, Pa Worker

What is claimed is:

1. A management apparatus comprising:
at least one memory configured to store instructions;
at least one storage storing master information that associates, with each other an appearance predetermined for one worker or a worker group who conducts work and a kind of the work; and
at least one processor configured to execute the instructions to perform operations comprising:
estimating a kind of work conducted by each of one or a plurality of workers, based on appearance information about an appearance of the one or the plurality of workers being acquired by analyzing a video in which a work region is captured, and the master information.

2. The management apparatus according to claim 1, wherein
the predetermined appearance includes at least one piece of information indicating a whole body, clothing, a pose, and behavior of the one worker who conducts the work or a plurality of workers constituting the worker group, and information indicating an article used for the work.

3. The management apparatus according to claim 1, wherein
the worker group is formed of a plurality of workers who conduct the work together.

4. The management apparatus according to claim 1, wherein
the appearance predetermined for the worker group who conducts the work includes at least one of a number and a positional relationship of a plurality of workers constituting the worker group.

5. The management apparatus according to claim 1, the operations further comprising
outputting management information, based on a result estimated by the estimation.

6. The management apparatus according to claim 5, wherein
the management information includes a number of workers who conduct a same kind of work.

7. The management apparatus according to claim 6, wherein
the management information includes a number of workers who conduct a same kind of work by time period.

8. The management apparatus according to claim 1, the operations further comprising
estimating a work time of each of the one or the plurality of workers, based on the appearance information and the master information.

9. The management apparatus according to claim 1, wherein
the video is one of a plurality of videos in which the work region is captured from different directions, and
the kind of work conducted by each of one or a plurality of workers is estimated, based on appearance information about an appearance of the one or the plurality of workers being acquired by analyzing the plurality of videos in which the work region is captured, and the master information.

10. The management apparatus according to claim 1, the operations further comprising
generating, when a person included in the video is an unregistered person who is not registered in worker information, unregistered information about the unregistered person.

11. The management apparatus according to claim 10, wherein
the unregistered information includes at least one of an image including the unregistered person and behavior of the unregistered person.

12. The management apparatus according to claim 10, the operations further comprising
displaying the unregistered information on a display.

13. A management system comprising:
the management apparatus according to claim 1; and
a capturing apparatus that captures the work region, and transmits video data including a video in which the work region is captured.

14. A management method comprising,
by a computer:
storing, in a master storage unit, master information that associates, with each other, an appearance predetermined for one worker or a worker group who conducts work and a kind of the work; and
estimating a kind of work conducted by each of one or a plurality of workers, based on appearance information about an appearance of the one or the plurality of workers being acquired by analyzing a video in which a work region is captured, and the master information.

15. A non-transitory computer readable storage medium storing a program for causing a computer to execute:
storing master information that associates, with each other, an appearance predetermined for one worker or a worker group who conducts work and a kind of the work; and
estimating a kind of work conducted by each of one or a plurality of workers, based on appearance information about an appearance of the one or the plurality of workers being acquired by analyzing a video in which a work region is captured, and the master information.
